(19) United States
(12) Patent Application Publication
(10) Pub. No.: US 2006/0134512 A1
(43) Pub. Date: Jun. 22, 2006

(54) Jelly-roll electrode assembly and lithium rechargeable battery including the same

(76) Inventor: Soon Ki Woo, Youngin-si (KR)

Correspondence Address: H.C. PARK & ASSOCIATES, PLC, 8500 LEESBURG PIKE, SUITE 7500, VIENNA, VA, 22182, US

(21) Appl. No.: 11/283,686

(22) Filed: Nov. 22, 2005

(30) Foreign Application Priority Data
Nov. 29, 2004 (KR) 10-2004-0098864

(51) Int. Cl. H01M 6/10; H01M 2/14

(52) U.S. Cl. 429/94; 429/129

(57) ABSTRACT

A jelly-roll electrode assembly includes an extensible fixing layer fixing the shape of the jelly-roll electrode assembly.

### CROSS REFERENCE TO RELATED APPLICATIONS

This application claims priority to and benefit of Korean Patent Application No. 10-2004-0098864, filed on Nov. 29, 2004, which is hereby incorporated by reference for all purposes as if fully set forth herein.

### BACKGROUND OF THE INVENTION

1. Field of the Invention

The present invention relates to a jelly-roll electrode assembly that includes an extensible fixing layer made of extensible material to maintain the configuration of the jelly-roll electrode and a lithium rechargeable battery that includes the jelly-roll electrode assembly.

2. Discussion of the Background

Rechargeable batteries are commonly used in portable electronic devices because it is often more economical to recharge rather than replace the batteries. Lithium rechargeable batteries are especially advantageous because of their high operating voltage and energy density.

Lithium rechargeable batteries are classified as either liquid electrolyte batteries or polymer electrolyte batteries depending on the type of electrolyte solution that is used. A lithium ion battery uses a liquid electrolyte, and a lithium polymer battery uses a polymer electrolyte. Lithium rechargeable batteries may be manufactured in various shapes such as a cylinder, a polygon, and a pouch.

A cylindrical lithium rechargeable battery may include a cylindrical case containing an electrode assembly and an electrolyte solution. The electrode assembly may include a positive electrode plate with a positive electrode activation layer, a negative electrode plate with a negative electrode activation layer, and a separator interposed between the positive electrode plate and the negative electrode plate to prevent a short-circuit between them. The elements of the electrode assembly may be spirally wound into a configuration known as a jelly-roll.

A method of manufacturing a conventional cylindrical lithium rechargeable battery is described below.

A positive electrode activation layer is formed on the positive electrode plate, and the positive electrode plate is connected to a positive electrode tap. A negative electrode activation layer is formed on the negative electrode plate, and the negative electrode plate is connected to a negative electrode tap. The positive electrode plate, a separator and the negative electrode plate are stacked and spirally wound into a jelly-roll configuration. A tape may be wound around the outside of the jelly-roll electrode assembly between the distal ends of the jelly-roll electrode assembly to prevent the jelly-roll electrode assembly from unwinding.

The jelly-roll electrode assembly is then placed in the cylindrical case, a process for preventing the jelly-roll electrode assembly from separating is performed, the electrolyte solution is injected into the cylindrical case, and a sealing process is performed to complete the cylindrical lithium rechargeable battery.

The positive and negative electrode activation layers include positive and negative electrode activation materials for generating and transferring electrons in a battery reaction and a binder for attaching the positive and negative electrode activation materials to the positive and negative electrode plates, respectively. A lithium oxide material may be used as a positive electrode activation material, and a carbon material may be used as a negative electrode activation material.

A non-aqueous system obtained by dissolving polyvinylidene fluoride (PVDF) with an organic solvent such as N-methyl-2-pyrrolidone (NMP) or acetone may be used as a binder for the negative electrode activation layer. However, when the PVDF/NMP non-aqueous system is used as a binder, the organic solvent may contaminate the environment. The use of organic solvent increases the production costs of the lithium battery because the organic solvent is relatively expensive. In addition, there is a chance of an explosion when the organic solvents are used in an enclosed space because most of the organic solvents are highly volatile. Therefore, explosion proof facilities are required at additional cost.

In order to solve these problems, an aqueous binder system has been developed in which styrene-butadiene rubber (SBR) and a viscosity agent such as carboxymethyl cellulose (CMC) are dispersed in water during the production of the negative electrode plate. This method does not require an organic solvent because the SBR binder can be dispersed into water as an emulsion. Less binder may be used because the SBR binder has a high adhesive force. This allows the amount of the negative electrode activation material to be increased, which increases the capacity of the lithium battery.

The CMC viscosity agent generates a gas at high temperatures when carboxyl in the CMC is dissolved. The gas may cause battery characteristics such as the capacitance maintaining rate to deteriorate.

In addition, swelling may occur due to the gas generated at high temperatures, which causes the jelly-roll electrode assembly to expand at high temperatures or during charging periods. The swelling may be much more serious when SBR is used as a binder as compared to when PVDF is used as a binder.

When SBR is used as a binder, the tape used to prevent the jelly-roll electrode assembly from unwinding may not extend to accommodate the increase in the electrode's size when it swells. Therefore, the jelly-roll electrode assembly will be squeezed by the tape so that it may not expand uniformly, which may deform the assembly. The deformation may cause the thermal stability and charging stability of the lithium rechargeable battery to deteriorate.

### SUMMARY OF THE INVENTION

This invention provides a jelly-roll electrode assembly that includes an extensible fixing layer. The extensible fixing layer may be fixed to the outermost surface of the jelly-roll electrode assembly. If the jelly-roll electrode assembly swells, the extensible fixing layer may stretch to maintain the shape and improve the thermal stability and charging stability of the jelly-roll electrode assembly.

Additional features of the invention will be set forth in the description which follows, and in part will be apparent from the description, or may be learned by practice of the invention.

The present invention discloses a jelly-roll electrode assembly including a first electrode plate, a second electrode plate, a separator interposed between the first electrode plate and the second electrode plate insulating the first electrode plate from the second electrode plate, and at least one extensible fixing layer.

The present invention also discloses a lithium rechargeable battery that includes a jelly-roll electrode assembly including a first electrode plate, a second electrode plate, a separator interposed between the first electrode plate and the second electrode plate insulating the first electrode plate from the second electrode plate, and at least one extensible fixing layer.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1A and FIG. 1B are perspective views of electrode assemblies according to exemplary embodiments of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. In the drawings, like reference numerals denote like components.

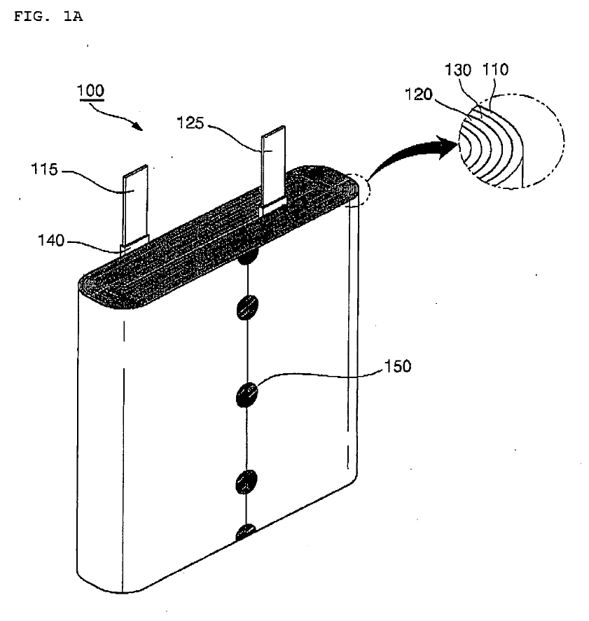

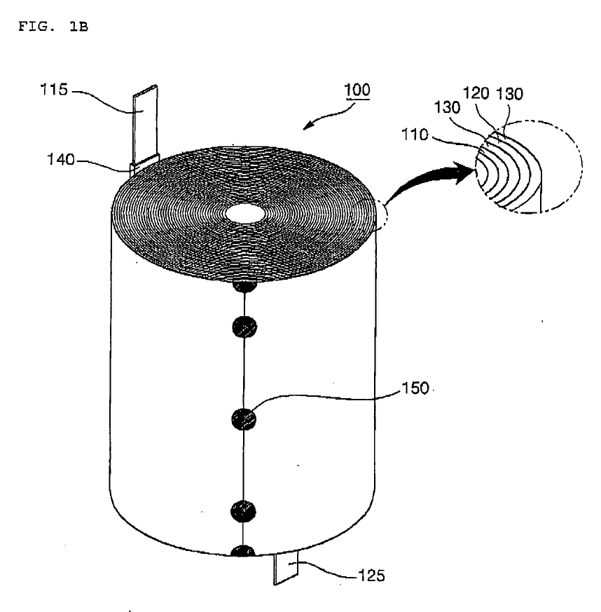

FIG. 1A and FIG. 1B are perspective views of electrode assemblies according to exemplary embodiments of the present invention.

Referring to FIG. 1A and FIG. 1B, a jelly-roll electrode assembly 100 of a lithium rechargeable battery according to an exemplary embodiment of the present invention includes a first electrode plate 110, a second electrode plate 120, and a separator 130 interposed between the first electrode plate 110 and second electrode plate 120. The first electrode plate 110, the second electrode plate 120, and the separator 130 are wound into a jelly-roll configuration. The jelly-roll electrode assembly 100 also includes at least one extensible fixing layer 150 arranged on the outermost surface of the jelly-roll electrode assembly for fixing the distal ends of the jelly-roll electrode assembly.

A first electrode tap 115 is attached to the first electrode plate 110. The first electrode tap 115 may protrude upward and may be made of aluminum (Al). A second electrode tap 125 is attached to the second electrode plate 120. The second electrode tap 125 may protrude downward and may be made of nickel (Ni). Insulating tapes 140 may be arranged at the boundaries where the first electrode tap 115 and the second electrode tap 125 protrude from the jelly-roll electrode assembly 100 to prevent a short-circuit between the first electrode plate 100 and the second electrode plate 120.

Each distal end of the jelly-roll may be fixed with at least one extensible fixing layer 150 on the outermost surface of the jelly-roll.

The first electrode plate 110 includes a conductive first electrode plate current collector and a first activation layer on the first electrode plate current collector. The first activation layer material may be either a positive or a negative electrode activation material. The first activation layer material shown in the exemplary illustrated embodiment is a positive electrode activation material. Aluminum (Al) may be used as the first electrode plate current collector.

The first activation layer is formed by coating the electrode current collector with the positive electrode activation layer material, a conductive material, and a positive electrode slurry. The first activation layer generates electrons through a positive electrode chemical reaction. The conductive material transfers the electrons from the positive activation layer to the electrode current collector. The positive electrode slurry is formed by mixing positive electrode binders in a solvent and is used to adhere the positive electrode activation material to the conductive material and maintain the mechanical strength of the positive electrode plate. The positive electrode activation layer material may be a chalcogenide compound such as a composite metal oxide such as LiCoO₂, LiMn₂O₄, LiNiO₂, LiNi₁₋ₓCoₓO₂ (0<x<1), and LiMnO₂.

The second electrode plate 120 includes a second electrode plate current collector that includes a conductive metal thin film and a second activation layer. The second activation layer material may be either a positive or a negative electrode activation material, but must have a polarity opposite to the polarity of the first activation layer material. The second activation layer material shown in the exemplary illustrated embodiment is a negative electrode activation material. Copper (Cu) or nickel (Ni) may be used for the second electrode plate current collector. The second activation layer is formed by coating the electrode current collector with a negative electrode activation material and a negative electrode slurry. The negative electrode activation material receives electrons through a negative electrode chemical reaction. The negative electrode slurry is formed by mixing negative electrode binders in a solvent and is used to adhere the negative electrode activation material to the electrode current collector and sustain the mechanical strength of the negative electrode plate. The negative electrode activation material may be made of a carbon (C) material, Si, Sn, tin oxide, composite tin alloy, a transition metal oxide, lithium metal nitride, or lithium metal oxide. The negative electrode binder may be an aqueous binder system obtained by dispersing styrene-butadiene rubber SBR and a viscosity agent such as carboxymethyl cellulose (CMC) into water.

The separator 130 prevents a short-circuit between the first electrode plate 110 and the second electrode plate 120 and transfers only the charges, for example, lithium ions of the cylindrical lithium rechargeable battery. The separator 130 may be made of polyethylene, polypropylene, or a co-polymer of polyethylene, and polypropylene. The separator 130 may be wider than the first electrode plate 110 and the second electrode plate 120 to prevent a short-circuit between the first electrode plate 110 and the second electrode plate 120.

The first electrode plate 110, the separator 130, and the second electrode plate 120 are formed as sheets, sequentially stacked, and then wound into a jelly-roll configuration. Alternatively, the separator 130 may be arranged to surround either the first electrode plate 110 or the second electrode plate 120 and then the first electrode plate 110, the second electrode plate 120, and the separator 130 may be wound into a jelly-roll configuration.

The extensible fixing layer 150 may be formed on portions of the surface of the outermost layer of the jelly-roll electrode assembly 100 at the distal ends of the jelly-roll electrode assembly 100 to maintain the stability of the jelly-roll configuration.

The extensible fixing layer 150 may be made of an extensible material so that the extensible fixing layer 150 may stretch with the jelly-roll electrode assembly 100 when the jelly-roll electrode assembly 100 swells. The extensible fixing layer 150 may be made of a silicon resin or an adhesive resin such as polyurethane resin and polyolefin resin such as polyethylene, polypropylene, modified polyethylene, and modified polypropylene. The extensible fixing layer 150 may be made of a material with an extensibility from about 50% to about 200%. The extensible fixing layer 150 may be formed by injecting or dropping the solution including the extensible fixing layer material and drying the solvent and pressing the surface of the outermost layer of the jelly-roll electrode assembly 100 on the distal ends of the jelly-roll electrode assembly 100.

The extensible fixing layer may be configured in a variety of shapes, such as circles, ovals, rectangles, and squares in any configuration or arrangement. The extensible fixing layer may include plural shapes or one shape. The extensible fixing layer may completely encircle the jelly-roll electrode assembly.

As shown in the exemplary embodiment of FIG. 1B, the outermost layer of the jelly-roll electrode assembly 100 in the cylindrical lithium secondary battery is the separator 130, and thus the separator 130 is fixed with the extensible fixing layer 150.

As shown in the exemplary embodiment of FIG. 1A, the outermost layer of the jelly-roll electrode assembly 100 in the rectangular lithium secondary battery is the first electrode plate 110, and thus the first electrode plate 110 is fixed with the extensible fixing layer 150. Alternatively, the second electrode plate 120 may be the outermost layer of the jelly-roll electrode assembly. In this case, the second electrode plate 120 would be fixed with the extensible fixing layer 150.

Styrene-butadiene rubber (SBR) may be used as the binder for the negative electrode activation material. The use of SBR as the binder of the negative electrode activation material causes the jelly-roll electrode assembly 100 to swell much more than it would if polyvinylidene fluoride (PVDF) were used as the binder. However, the extensible fixing layer 150 may be capable of stretching enough to accommodate the increased swelling of the jelly-roll electrode assembly 100.

The extensible fixing layer 150 may prevent the jelly-roll electrode assembly 100 from being non-uniformly deformed when it expands by stretching with the jelly-roll electrode assembly 100 rather than restricting it. This may prevent a short-circuit between the first electrode plate 110 and the second electrode plate 120.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A jelly-roll electrode assembly, comprising:
a first electrode plate;
a second electrode plate;
a separator interposed between the first electrode plate and the second electrode plate and insulating the first electrode plate from the second electrode plate; and
at least one extensible fixing layer fixing the shape of a jelly-roll electrode assembly.

2. The jelly-roll electrode assembly of claim 1,
wherein an extensible fixing layer is arranged on a portion of a distal end of the jelly-roll electrode assembly.

3. The jelly-roll electrode assembly of claim 1,
wherein the at least one extensible fixing layer comprises an adhesive.

4. The jelly-roll electrode assembly of claim 1,
wherein the at least one extensible fixing layer comprises a silicon resin.

5. The jelly-roll electrode assembly of claim 1,
wherein the separator is an outermost layer of the jelly-roll electrode assembly, and
wherein the separator is fixed with the extensible fixing layer.

6. The jelly-roll electrode assembly of claim 1,
wherein the first electrode plate or the second electrode plate is an outermost layer of the jelly-roll electrode assembly, and
wherein the outermost layer is fixed with the extensible fixing layer.

7. The jelly-roll electrode assembly of claim 1,
wherein the at least one extensible fixing layer has an extensibility from about 50% to about 200%.

8. The jelly-roll electrode assembly of claim 1,
wherein each of the first electrode plate and second electrode plate comprises an electrode current collector and an activation layer formed on the electrode current collector, and
wherein the activation layer comprises a binder comprising an activation material and styrene-butadiene rubber.

9. The jelly-roll electrode assembly of claim 8,
wherein the activation layer further comprises a viscosity agent.

10. A lithium rechargeable battery, comprising:
a jelly-roll electrode assembly comprising,
a first electrode plate;
a second electrode plate;
a separator interposed between the first electrode plate and the second electrode plate and insulating the first electrode plate from the second electrode plate; and
at least one extensible fixing layer fixing the jelly-roll electrode assembly.

11. The lithium rechargeable battery of claim 10,
wherein an extensible fixing layer is arranged on a portion of a distal end of the jelly-roll electrode assembly.

12. The lithium rechargeable battery of claim 10,
wherein the at least one extensible fixing layer comprises an adhesive.

13. The lithium rechargeable battery of claim 10,
wherein the at least one extensible fixing layer comprises a silicon resin.

14. The lithium rechargeable battery of claim 10,
wherein the separator is an outermost layer of the jelly-roll electrode assembly, and
wherein the separator is fixed with the extensible fixing layer.

15. The lithium rechargeable battery of claim 10,
wherein the first electrode plate or the second electrode plate is an outermost layer of the jelly-roll electrode assembly, and
wherein the outermost layer is fixed with the extensible fixing layer.

16. The lithium rechargeable battery of claim 10,
wherein the at least one extensible fixing layer has an extensibility from about 50% to about 200%.

17. The lithium rechargeable battery of claim 10,
wherein each of the first electrode plate and second electrode plate comprises an electrode current collector and an activation layer formed on the electrode current collector, and
wherein the activation layer comprises a binder comprising an activation material and styrene-butadiene rubber.

18. The lithium rechargeable battery of claim 17,
wherein the activation layer further comprises a viscosity agent.
